(19) United States
(12) Patent Application Publication
(10) Pub. No.: US 2006/0070942 A1
(43) Pub. Date: Apr. 6, 2006

(54) Water purifying apparatus

(75) Inventor: Jae Koog An, Gwangju-City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/221,859

(22) Filed: Sep. 9, 2005

(30) Foreign Application Priority Data
Oct. 1, 2004 (KR) 2004-78459

(51) Int. Cl. B01D 35/30

(52) U.S. Cl. 210/433.1; 210/450; 210/455; 210/497.01

(57) ABSTRACT

A water purifying apparatus in which a filter unit is easily attached to and detached from a connection unit. The water purifying apparatus includes a filter unit for allowing water to be circulated therein to filter out foreign substances from the water; and a connection unit connected to the filter unit for transmitting external water to the filter unit and then transmitting the purified water to the outside. The connection unit includes an outer case having a cylindrical structure, one end of which is closed and the other end of which is opened; an inner case having a cylindrical structure, one end of which is closed and the other end of which is opened; and sealing members installed between the inner surface of the closed end of the outer case and the outer surface of the closed end of the inner case.

### CROSS-REFERENCE TO RELATED APPLICATION

This application claims priority from Korean Patent Application No. 2004-78459, filed Oct. 1, 2004, in the Korean Intellectual Property Office, the disclosure of which is incorporated herein by reference.

### BACKGROUND OF THE INVENTION

1. Field of the Invention

The present invention relates to a water purifying apparatus and, more particularly, to a water purifying apparatus in which a filter unit is easily replaced with a new one.

2. Description of the Related Art

Generally, a water purifying apparatus, which serves to receive supplied water and to filter out foreign substances from the water, is usually contained in a water purifier. Recently, the water purifying apparatus is installed also in a refrigerator, and supplies drinking water or water for making ice cubes.

U.S. Pat. No. 4,948,505 discloses a conventional water purifying apparatus comprising a filter unit having a filter therein, and a connection unit for connecting an external water path and the filter unit.

The connection unit includes an inlet for receiving water from the outside, an outlet for discharging the water to the outside, and a pair of sealing members located in a circumferential direction for preventing the water from leaking through gaps between the filter unit and connection unit. Here, a pipe-shaped connection portion, which is rotated and connected to the connection unit, is protruded from the filter unit, and a connection hole, into which the connection portion is inserted, is formed through the connection unit. The sealing members having a disk shape are installed between the outer surface of the connection portion and the inner surface of the connection hole, thereby preventing the water from leaking through gaps between the connection portion and the connection hole.

In the above-described conventional water purifying apparatus, when the filter unit is rotated in order to be separated from the connection unit, the sealing members, which are installed between the outer surface of the connection portion of the filter unit and the inner surface of the connection hole of the connection unit in the same direction as the rotating direction of the filter unit, generate friction, and disturb the rotation of the filter unit, thereby causing a difficulty in separating the filter unit from the connection unit.

### SUMMARY OF THE INVENTION

Therefore, an aspect of the invention is to provide a water purifying apparatus, in which a filter unit is easily attached to and detached from a connection unit.

An apparatus consistent with the present invention provides a water purifying apparatus comprising: a filter unit for allowing water to be circulated therein to filter out foreign substances from the water; and a connection unit connected to the filter unit for transmitting external water to the filter unit and then transmitting the purified water to the outside, the connection unit including: an outer case having a cylindrical structure, one end of which is closed and the other end of which is opened, and provided with an inlet formed through the closed end for receiving the water from the outside and an outlet formed through the closed end for transmitting the purified water to the outside; an inner case having a cylindrical structure, one end of which is closed and the other end of which is opened, and provided with a first communication hole and a second communication hole formed through the closed end at positions corresponding to the positions of the inlet and the outlet according to an angle between the outer case and the inner case for communicating the inlet and the outlet with the filter unit; and sealing members installed between the inner surface of the closed end of the outer case and the outer surface of the closed end of the inner case for preventing the water from leaking through gaps between the outer case and the inner case.

The sealing members may include a first sealing member disposed outside the inlet and the first communication hole in the circumferential direction, and a second sealing member disposed outside the outlet and the second communication hole in the circumferential direction.

Further, a first sealing groove having a concave structure formed outside the first communication hole in the circumferential direction for mounting the first sealing member therein and a second sealing groove having a concave structure formed outside the second communication hole in the circumferential direction for mounting the second sealing member therein may be formed in one of the outer surface of the closed end of the inner case and the inner surface of the closed end of the outer case.

Moreover, a bypass groove for communicating the inlet and the outlet with each other when the outer case and the inner case meet at a designated angle may be formed in the outer surface of the closed end of the inner case.

The first and second communication holes may be symmetrically formed at both sides of the closed end of the inner case; and the bypass groove may form an angle of 90° with a line connecting the first and second communication holes.

### BRIEF DESCRIPTION OF THE DRAWINGS

These and/or other aspects and advantages of the invention will become apparent and more readily appreciated from the following description of the exemplary embodiments, taken in conjunction with the accompanying drawings, in which:

FIG. 1 is an exploded perspective view of a water purifying apparatus consistent with the present invention;

FIG. 2 is a longitudinal sectional view of the water purifying apparatus consistent with the present invention; and

FIG. 3 is a longitudinal sectional view of the water purifying apparatus of the present invention, from which a filter is separated.

### DETAILED DESCRIPTION OF THE ILLUSTRATIVE, NON-LIMITING EMBODIMENTS OF THE INVENTION

Reference will now be made in detail to the illustrative, non-limiting embodiment of the present invention, an example of which is illustrated in the accompanying drawings, wherein like reference numerals refer to like elements throughout. The exemplary embodiment is described below to explain the present invention by referring to the accompanying drawings.

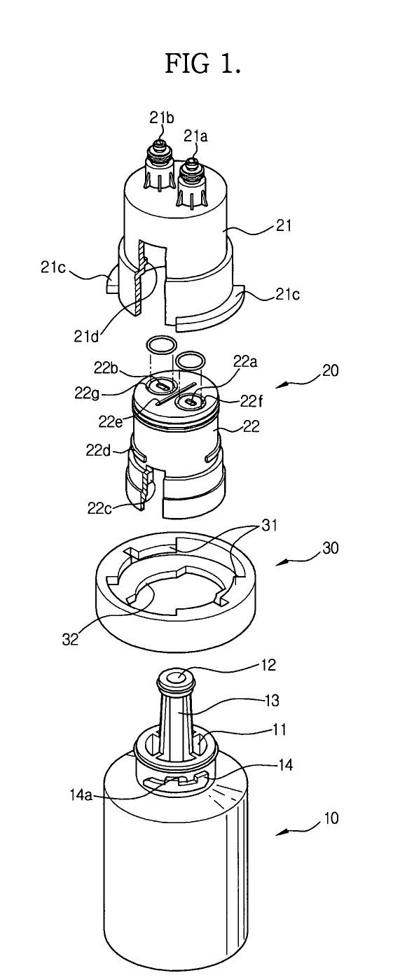

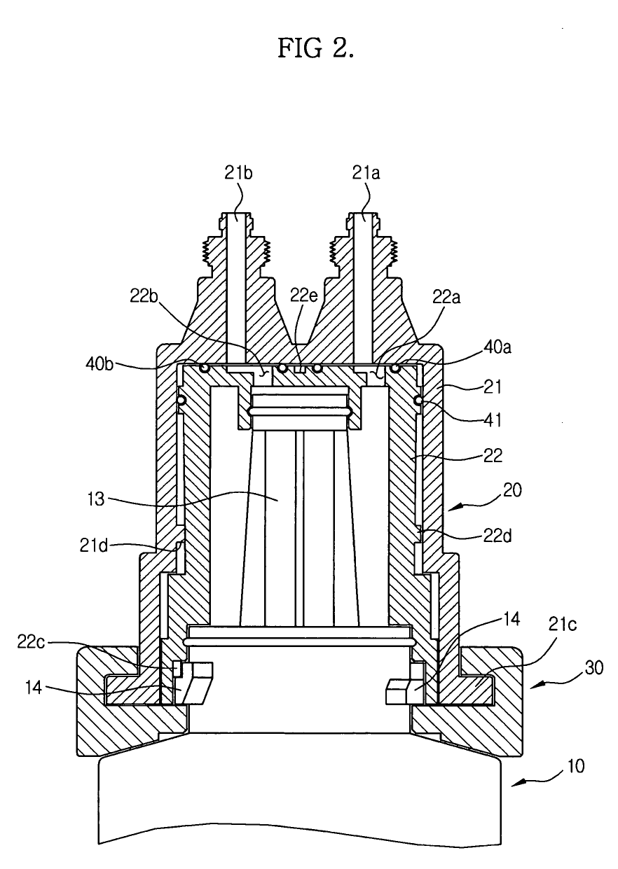

As shown in FIGS. 1 and 2, a water purifying apparatus consistent with the present invention comprises a filter unit 10 for filtering out foreign substances from water passing therethrough so that the water is purified, and a connection unit 20 for connecting the filter unit 10 to an external water path so that external water is transmitted to the filter unit 10 and simultaneously the water purified by the filter unit 10 is transmitted to the external water path.

The filter unit 10 has a cylindrical structure, which is filled with a filtering substance for purifying the water, and includes an outlet 12 formed through the central portion of the upper part thereof for transmitting the purified water to the outside, and an inlet 11 formed through the upper part thereof outside the outlet 12 for receiving the external water. Here, a guide pipe 13, which is connected to the connection unit 20, is protruded from the filter unit 10 and includes the outlet 12 at the end thereof. The inside of the guide pipe 13 forms a channel guiding the discharged water, and a space between the external surface of the guide pipe 13 and the connection unit 20 forms a channel guiding the water from the connection unit 20 to the inlet 11.

The connection unit 20 includes an outer case 21 provided with an inlet 21a opened in the axial direction for receiving the water from the outside and an outlet 21b opened in the axial direction for transmitting the purified water to the outside, and an inner case 22 rotatably installed in the outer case 21 for communicating selectively with the inlet 21a and the outlet 21b of the outer case 21 based on the angle with the outer case 21 and simultaneously communicating with the inlet 11 and the outlet 12 of the filter unit 10. For this reason, a first communication hole 22a for communicating the inlet 21a and the inlet 11 with each other and a second communication hole 22b for communicating the outlet 21b and the outlet 12 with each other are formed through the inner case 22. Here, the first and second communication holes 22a and 22b are selectively operated based on the angle between the outer case 21 and the inner case 22.

The outer case 21 has a cylindrical structure, one end of which is closed and the other end of which is opened, and the above-described inlet 21a and outlet 21b are symmetrically formed at both sides on the closed end surface of the outer case 21. Identically with the outer case 21, the inner case 22 has a cylindrical structure, one end of which is closed and the other end of which is opened, and the above-described first communication hole 22a and second communication hole 22b corresponding to the inlet 21a and the outlet 21b are symmetrically formed at both sides of the closed end surface of the inner case 22.

The inner case 22 is rotatably installed in the opened outer case 21. When the inner case 22 forms a designated angle with the outer case 21, the first communication hole 22a formed through the inner case 22 communicates a space between the guide pipe 13 and the internal case 22 with the inlet 21a, and the second communication hole 22b formed through the inner case 22 communicates the inside of the guide pipe 13, i.e., the outlet 12, with the outlet 21b (see FIG. 2).

Accordingly, when the designated angle is formed between the inner case 22 and the outer case 21, the inlet 21a communicates with the first communication hole 22a, and the outlet 21b communicates with the second communication hole 22b, thereby allowing the external water to sequentially pass through the inlet 21a, the first communication hole 22a, and the inlet 11, and to flow to the inside of the filter 10 to be purified, and then the purified water to sequentially pass through the guide pipe 13, the outlet 12, the second communication hole 22b, and the outlet 21b to be discharged to the outside. Thereafter, when the filter unit 10 is rotated so as to be separated from the connection unit 20, the inner case 22 is rotated in the outer case 21 together with the rotation of the filter unit 10, so that the positions of the inlet 21a and the first communication hole 22a are deviated from each other and the positions of the outlet 21b and the second communication hole 22b are deviated from each other, thereby preventing the inflow/outflow of water by means of the closed end surface of the inner case 22.

The water purifying apparatus of the present invention further comprises a fixing bracket 30 for fixing the connection unit 20 and the filter unit 10 to each other. The fixing bracket 30 has a disk-shaped structure, and the outer case 21 is installed on one axial side of the fixing bracket 30 and the filter unit 10 is installed on the other axial side of the fixing bracket 30. Thereby, the fixing bracket 30 serves to fix the connection unit 20 and the filter unit 10 to each other. For this reason, first extensions 31, on which the external case 21 is latched, are protruded from one axial side of the inner surface of the fixing bracket 30, and second extensions 32, on which the filter unit 10 is latched, are protruded from the other axial side of the inner surface of the fixing bracket 30. First protrusions 21c, which are latched onto the first extensions 31, are formed on both sides of the outer surface of the external case 21, and second protrusions 14, which are latched on the second extensions 32, are formed on the outer surface of the filter unit 10. Accordingly, when the first protrusions 21c and the second protrusions 14, which are respectively formed on the lower end of the external case 21 and the upper end of the filter unit 10, are inserted into the fixing bracket 30 avoiding sections of the first extensions 31 and the second extensions 32, and are then rotated, the first protrusions 21c are latched on the first extensions 31 and the second protrusions 14 are latched on the second extensions 32, thereby vertically connecting the connection unit 20 and the filter unit 10 through the fixing bracket 30.

Here, in order to rotate the inner case 22 together with the rotation of the filter unit 10, concave portions 14a are formed in the second protrusions 14 of the filter unit 10 and convex portions 22c are protruded on the inner surface of the inner case 22. Accordingly, when the filter unit 10 and the connection unit 20 are fixed to each other through the fixing bracket 30, the convex portions 22c of the inner case 22 are inserted into the concave portions 14a of the filter unit 10, and the inner case 22 receives rotary force from the filter unit 10 through the concave portions 22c, thereby being rotated together with the rotation of the filter unit 10.

Further, the inner case 22 is rotated in a designated range inside the outer case 21. For this reason, a stopper portion 22d is protruded from the outer surface of the inner case 22, and a stopper 21d is protruded from the inner surface of the outer case 21, so that the inner case 22 is rotated in the designated range inside the outer case 21 by the stopper 21d and the stopper portion 22d. In this embodiment of the present invention, the inner case 22 is rotated in the range of 90° in a designated direction and the reverse direction.

A bypass groove 22e is formed in the inner case 22 so that the water which flows into the outer case 21 through the inlet 21a is directly guided to the outlet 21b when the filter unit 10 is separated from the connection unit. The bypass groove 22e is engraved in the outer surface of the closed end of the inner case 22, and is located between the first communication hole 22a and the second communication hole 22b. In this exemplary embodiment of the present invention, since the inner case 22 can be rotated at the angle of 90°, the bypass groove 22e is longitudinally extended to be orthogonal to a virtual line connecting the first communication hole 22a and the second communication hole 22b.

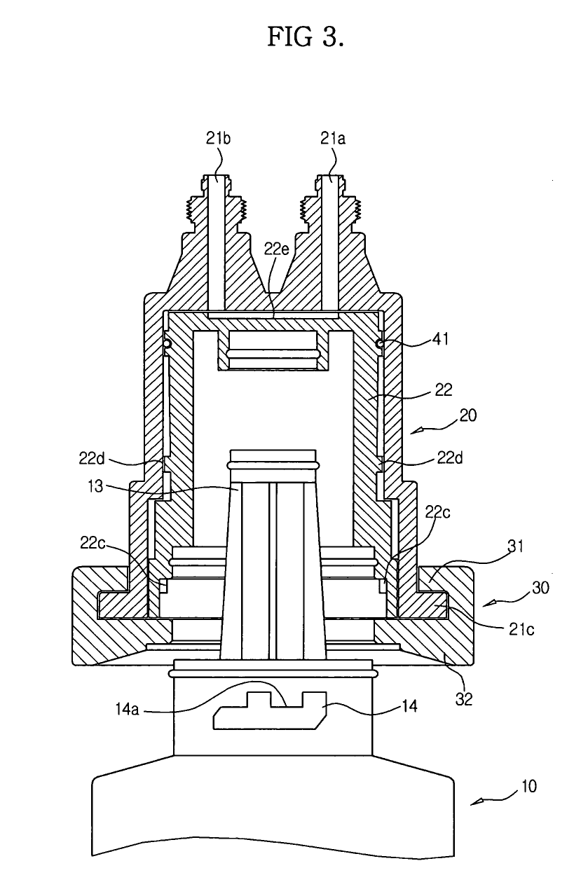

Accordingly, when the water purifying apparatus of the present invention performs a water-purifying operation, the positions of the inlet 21a and the first communication hole 22a correspond to each other, and the positions of the outlet 21b and the second communication hole 22b correspond to each other. Thereafter, when the filter unit 10 is rotated at the angle of 90° in order to be separated from the connection unit 20, the inner case 22 is rotated at the angle of 90° together with the rotation of the filter unit 10, and the water which flows to the inlet 21a is guided to the outlet 21b through the bypass groove 22e and is then discharged to the outside (see FIG. 3).

Further, in order to prevent water from leaking through gaps between the outer case 21 and the inner case 22 when the external water is transmitted to the filter unit 10 through the connection unit 20 and the water in the filter unit 10 is transmitted to the outside through the connection unit 20, sealing members 40a and 40b are installed between the outer case 21 and the inner case 22.

The sealing members 40a and 40b are made of a material, such as rubber, which can be elastically deformed. The sealing members 40a and 40b are elastically deformed and contact the outer case 21 and the inner case 22, thereby preventing the water from leaking through the gaps between the outer case 21 and the inner case 22. In this embodiment of the present invention, the sealing members 40a and 40b include a first sealing member 40a for preventing the water passing through the inlet 21a and the first communication hole 22a from leaking, and a second sealing member 40b for preventing the water passing through the second communication hole 22b and the outlet 21b from leaking.

Here, both side surfaces of the first sealing member 40a and the second sealing member 40b respectively contact the inner case 22 and the outer case 21. Accordingly, when the inner case 22 is rotated, friction between the first and second sealing members 40a and 40b and the outer and inner cases 21 and 22 is generated. Since the first sealing member 40a and the second sealing member 40b, which are installed between the inner surface of one end of the outer case 21 and the outer surface of one end of the inner case 22, are arranged closely to the rotary center of the inner case 22, a moment force generated due to the friction is thereby reduced. Accordingly, in order to rotate the inner case 22, a small rotary force is applied to the inner case 22.

A first sealing groove 22f and a second sealing groove 22g are respectively formed in the outer surface of the closed end of the inner case 22 around the circumferences of the first communication hole 22a and the second communication hole 22b, and the first and second sealing members 40a and 40b are respectively mounted in the first and second sealing grooves 22f and 22g.

A subsidiary sealing member 41, for preventing the water from leaking through the gaps between the inner case 22 and the outer case 21 when the filter unit 10 is separated from the connection unit 20 so that the water passes through the bypass groove 22e, is installed between the inner surface of the outer case 21 and the outer surface of the inner case 22.

Although the first and second sealing grooves 22f and 22g are formed in the outer surface of the closed end of the inner case 22 in this exemplary embodiment, the positions of the first and second sealing grooves 22f and 22g are not limited thereto. That is, the first and second sealing grooves 22f and 22g may be formed in the inner surface of the closed end of the outer case 21.

As apparent from the above description, the present invention provides a water purifying apparatus, in which an inlet for receiving water supplied from the outside and an outlet for discharging the water to the outside are formed through an outer case in the axial direction, and sealing members for preventing the water from leaking through gaps between the outer case and an inner case are installed between closed ends of the outer and inner cases so that friction between the outer case 21 and the inner case 22 is reduced by the sealing members, thereby allowing the inner case to be easily rotated in the outer case.

Although an exemplary embodiment of the invention has been shown and described, it will be appreciated by those skilled in the art that changes may be made in this embodiment without departing from the principles and spirit of the invention, the scope of which is defined in the claims and their equivalents.

What is claimed is:

1. A water purifying apparatus comprising:
a filter unit for allowing water to be circulated therein to filter out foreign substances from the water; and
a connection unit connected to the filter unit for transmitting external water to the filter unit and then transmitting purified water to the outside, said connection unit including:
an outer case having a cylindrical structure, one end of which is closed and another end of which is opened, and provided with an inlet formed through the closed end for receiving the water from the outside and an outlet formed through the closed end for transmitting the purified water to the outside;
an inner case having a cylindrical structure, one end of which is closed and another end of which is opened, and provided with a first communication hole and a second communication hole formed through the closed end at positions corresponding to positions of the inlet and the outlet according to an angle between the outer case and the inner case for communicating the inlet and the outlet with the filter unit; and
sealing members installed between the inner surface of the closed end of the outer case and the outer surface of the closed end of the inner case for preventing the water from leaking through gaps between the outer case and the inner case.

2. The water purifying apparatus as set forth in claim 1, wherein the sealing members include a first sealing member disposed outside the inlet and the first communication hole in a circumferential direction, and a second sealing member disposed outside the outlet and the second communication hole in the circumferential direction.

3. The water purifying apparatus as set forth in claim 2, wherein a first sealing groove having a concave structure formed outside the first communication hole in the circumferential direction for mounting the first sealing member therein and a second sealing groove having a concave structure formed outside the second communication hole in the circumferential direction for mounting the second sealing member therein are formed in one of the outer surface of the closed end of the inner case and the inner surface of the closed end of the outer case.

4. The water purifying apparatus as set forth in claim 1, wherein a bypass groove for communicating the inlet and the outlet with each other when the outer case and the inner case meet at a designated angle is formed in the outer surface of the closed end of the inner case.

5. The water purifying apparatus as set forth in claim 4, wherein:
the first and second communication holes are symmetrically formed at both sides of the closed end of the inner case; and
the bypass groove forms an angle of 90° with a line connecting the first and second communication holes.

6. A water purifying apparatus comprising:
a filter unit for allowing water to be circulated therein to filter out foreign substances from the water;
a connection unit connected to the filter unit for transmitting external water to the filter unit and then transmitting the purified water to the outside; and
a fixing bracket for fixing the connection unit and the filter unit to each other,
said connection unit including:
an outer case provided with an inlet for receiving the water from the outside and an outlet for transmitting the purified water to the outside;
an inner case installed in the outer case and provided with a first communication hole and a second communication hole for communicating the inlet and the outlet with the filter unit according to an angle between the outer case and the inner case; and
sealing members installed between the outer case and the inner case for preventing the water from leaking through gaps between the outer case and the inner case.

7. The water purifying apparatus as set forth in claim 6, wherein the sealing members include a first sealing member disposed outside the inlet and the first communication hole in the circumferential direction, and a second sealing member disposed outside the outlet and the second communication hole in the circumferential direction.

8. The water purifying apparatus as set forth in claim 6, wherein a bypass groove for communicating the inlet and the outlet with each other when the outer case and the inner case meet at a designated angle is formed in the outer surface of one end of the inner case.

9. The water purifying apparatus as set forth in claim 6, wherein a stopper portion is protruded from the outer surface of the inner case and a stopper is protruded from the inner surface of the outer case so that the inner case is rotated in a designated range.

10. The water purifying apparatus as set forth in claim 6, wherein concave portions are formed in the fixing bracket and convex portions are protruded from the inner case and inserted into the concave portions so that the inner case is rotated together with the rotation of the filter unit.

11. The water purifying apparatus as set forth in claim 6, wherein first extensions, on which the outer case is latched, and second extensions, on which the filter unit is latched, are protruded from the fixing bracket.

12. The water purifying apparatus as set forth in claim 6, wherein a subsidiary sealing member, for preventing the water from leaking through the gaps between the outer case and the inner case, is installed between the outer case and the inner case.

13. The water purifying apparatus as set forth in claim 11, wherein first protrusions, which are latched onto the first extensions, are formed on the outer case, and second protrusions, which are latched onto the second extensions, are formed on the filter unit.
